(19) United States
(12) Patent Application Publication
(10) Pub. No.: US 2005/0100015 A1
(43) Pub. Date: May 12, 2005

(54) Multicast peering in multicast points of presence (MULTIPOPs) network-neutral multicast internet exchange

(76) Inventor: Thomas Marshall Eubanks, Clifton, VA (US)

Correspondence Address: SUGHRUE MION, PLLC, 2100 PENNSYLVANIA AVENUE, N.W., SUITE 800, WASHINGTON, DC, 20037, US

(21) Appl. No.: 10/870,439

(22) Filed: Jun. 18, 2004

Related U.S. Application Data
(63) Continuation of application No. 09/725,683, filed on Nov. 30, 2000, now abandoned.
Application No. 09/725,683 is a continuation of application No. 09/595,013, filed on Jun. 16, 2000, now abandoned.

(51) Int. Cl. H04L 12/56

(52) U.S. Cl. 370/390

(57) ABSTRACT

Development of a trusted third party Multicast Points of Presence (or MULTIPOPs) Network, termed “A Neutral Multicast Exchange”, which will enable access, via the trusted third party, to a large proportion of end-users who are attached to the Internet through regional or local Internet Service Providers (ISPs). The business goal is to reduce the cost of Internet audio distribution to a level substantially below that of terrestrial broadcasting, and to develop the capability to distribute these broadcasts as widely as possible.

This Application is a continuation in part of U.S. patent application Ser. No. 09/595,013 filed Jun. 16, 2000, whose disclosure is incorporated herein, by reference, in its entirety.

### BACKGROUND OF THE INVENTION

Broadband Internet access is becoming more and more prevalent. However, the current technology for delivering streaming media across the Internet is too expensive to be profitable at typical advertising rates. Multicasting will make streaming media profitable by substantially lowering the cost of audio/visual data transport, but the operational deployment of multicasting has been slow, primarily because of the business and technical issues associated with multicast peering.

Of the many current estimates for the growth of broadband access (FIG. 1, from The Industry Standard, shows 3 recent surveys), the details differ, but DSL penetration in late 2000 is thought to be at least one million people, with a somewhat larger number receiving broadband access from cable modems. An even larger number of people have broadband connections at work, while Multiple Dwelling Units (MDUs), where an entire building shares broadband connectivity over a LAN, probably serves a comparable population. An interesting subset of the MDU population is comprised of college students in dormitories, who already mostly have broadband access. Since the total number of students in higher education is about 14 million, an estimate of 1 million students with broadband access is probably conservative, and the student population with broadband access night be as large as the entire rest of the broadband population put together. Adding all of these groups together, the total population with residential broadband is somewhere in the range of 3 to 6 million people, and it is clearly growing rapidly. Although these numbers are small compared to the total on-line population, they constitutes the equivalent of a major radio market. According to the Arbitron Blue Book for 2000, the total broadband population would, if considered as a single radio market, be between the 4th and the 14th largest radio markets in the country [Blue Book, 2000]. Of the total broadband population, an estimated one million are in the multicast enabled Internet, which is equivalent to the 40th largest radio market in the country, ahead of Austin, Tex., and Nashville, Tenn.

A poorly kept secret in Internet broadcasting is that with current technology it is impossible for streaming media sites to be profitable from audio advertisements alone. In order to be profitable, it is at a minimum necessary for the marginal cost of delivering a stream (a broadcast audio or visual program to one recipient) to be less than the revenue derived from advertising on that stream. (The revenue for terrestrial broadcast media is predominately derived from placing advertisements, and it is unlikely that Internet broadcasters will be able to develop substantial additional sources of revenue.) The cost of data transport as present is so high that existing Internet radio stations have tiny audiences. In the July 13 issue of the Radio And Internet Newsletter [RAIN, 2000]), Kurt Hanson analyses the latest Arbitron audience surveys (for February, 2000), and shows that the largest Internet station in February had an average audience of 338 people. It is simply too expensive for the existing stations to broadcast to many more people than that simultaneously.

To adequately estimate the profitability of Internet broadcasting, it is necessary to model both the sources of revenue and the costs of the distribution. The following analysis focuses on the marginal costs, as fixed costs (rent, cost for DJ's, cost for content, etc.) should be similar between the various means of broadcasting.

The major source of revenue from broadcasting is advertising. Even though Internet broadcasting allows for a variety of revenue sources, inventor's analysis indicates that audio ads will provide over 90% of the total revenue stream, and so for the purposes of this analysis any additional revenue sources can be ignored.

Commercial radio audio advertising is based on 60 and 30 second ads, with a 30 second ad price typically being ⅔ that of a 60 second spot. These are ads are carried along with program content, with typically 10-14 ad spots being placed in a one hour interval. If a nominal 12 ad slots are assumed per hour, then the effective duration of each ad slot is 5 minutes (this includes the other programming that is carried along with the ads).

Determining the actual revenue from an audio stream requires consideration of the listening “duty cycle.” Most Internet broadcasting sites (just as most terrestrial radios) show a strong variation in audience during a day, as much as a factor of ten between peak day time listenership and the dead times in the middle of the night, while Internet bandwidth must be paid for even during those dead times. The broadcast infrastructure, including data transport, must be paid for even at times when hardly anyone is listening, and therefore there is hardly any advertising revenue. Expressing this effect in terms of a “duty cycle”, D, which is the ratio of the time that the full audience is present to the full time available. Examination of radio logs for both terrestrial and Internet broadcasters indicates that the duty cycle D ˜⅓ (i.e., that the peak audience lasts about for 8 hours per day), and this value is assumed hereafter. (The Arbitron surveys thus imply a peak audience for the largest Internet radio of about 1000 listeners.)

In broadcasting, audio advertising is generally sold through a cost per thousand impressions (or CPM) basis, with the National Association for Broadcasting (NAB) statistics for the entire terrestrial radio industry providing an estimated average CPM of $7.60 for for 1999 (assuming that the average listener listens for 3 hours per day). This estimate implicitly includes the effects of 30 second versus 60 second ads, promotions etc., and we assume for simplicity that the same ratio of short and long ads, ad promotion special rates, etc., prevails in Internet broadcasting.

Using the average CPM of terrestrial radio of $7.60, a duty cycle of ⅓, and assuming 12 ads per hour, the monthly revenue from a single audio stream is thus about $22.0. (Note that this is NOT the same as the average monthly revenue per listener, as listeners do not typically listen for 8 hours per day.) In order for Internet audio broadcasting to have a chance at being profitable while competing with terrestrial radio, the marginal cost of delivering that stream to the listener has to be less than that number.

There are four competing technologies for large scale Internet broadcasts: direct unicasting, distributed caching, satellite delivery, and multicasting. Of course, the biggest competitor for any Internet broadcaster in the long run is terrestrial radio; all five broadcasting techniques will be considered in turn.

Direct Unicasting.

Although this is currently used by the vast majority of Internet radio stations, it is very expensive due to the high marginal costs for data transport. The current bulk rate for Internet data transport about $400 per megabit per second per month. In order to deliver high quality sound to end users, a bit rate of at least 128 kbps is required, and 200 kbps or more is required if the signal is going to be protected against transmission losses through the use of Forward Error Correction (FEC). I therefore considered the costs of two possible streams: high quality (250 kbps) and moderate quality (100 kbps). (Although most Internet audio broadcasting currently uses lower data rates, these do not sound nearly as good as FM broadcasts; it seems highly unlikely that a profitable business can be built offering an audio experience substantially worse than the biggest competitor.) The marginal cost of a stream, at the above bulk rate, is thus $100 per month for the high quality, and $40 per month for the moderate quality. This alone indicates how unfavorable the numbers are for Internet radio, but the real facts are even worse—with small audiences, the fixed costs cannot be ignored, and the bulk rate cannot be obtained. Even at an advertising rate several times that of terrestrial radio, unicast broadcasting therefore cannot be profitable. Although it is true a “Moore's law” is operating in the cost of bandwidth, reducing it by a factor of 2 every 12 to 18 months, it will still take years before the bulk data transport cost is reduced enough for unicast audio broadcasts to be profitable.

Web Caching Content Distribution Systems.

Web caching systems, such as those operated by Akamai, Digital Island and Sandpiper, speed the delivery of web pages through caching content in the interior of the Internet, or at Points of Presence (POPs) close to the end-user. A good overview of operation of existing web caching systems is given by [Polouchkine, 2000].

When the user requests a cached web page, it is retrieved from a “near-by” cache, instead of a central repository, which cuts down on the load on web host, reduces congestion, and speeds the delivery of the cached pages. The efficiency of web caching systems enhanced by Zipf's law [Breslau, 1999], where a relatively small fraction of the total number of web pages are the cause of the majority of the web traffic. With a Zipf's law distribution for web page requests, a considerable increase in the speed of the average web transaction can be accomplished through the caching of a relatively small number of pages. It is thus not necessary to cache the entire web, only a small fraction of it.

Since web pages are generally requested using hyperlinks from other web pages (or by links directly entered by the user), it is necessary to transparently redirect web page requests to a cache POP. There are two basic means of doing this: dynamical modification of web pages (Akamai and Digital Island/Sandpiper) and domain name redirects (Adero in addition to Akamai and Sandpiper as well).

In dynamical web page modification, references to content host web pages (at, say, xyz.com) are replaced by a reference to a local cache (at, say, cache.net) so that, e.g., http://www.xyz.com is replaced by http://www.cacheNNN.cachenet.com. This has the great advantage that the content host can select exactly which items are cached, and the local cache can serve web pages specifically configured for its location (i.e., with references to the cache host for cached pages, but with direct links to the host in the case of CGI type interactions, infrequently accessed pages, etc.). Infrequently referenced web pages, or those that require, e.g., CGI interactivity, can be simply left as is, and served from the content host site. In downside of this system is that web pages requests must be captured in some fashion to be modified, which requires that cache servers be located in the path between the user and the content host, and that they monitor traffic along this path.

The domain name redirect technique takes advantage of the distributed nature of the Domain Name System (DNS), which contains the mapping between domain names and Internet addresses. If an Internet host needs to send to an arbitrary domain name, this name is fetched from the nearest DNS server. If that server does not know the domain name to IP address mapping, it requests it from another DNS server, and so on, until, if necessary, the IP address is fetched from the DNS server for the domain name in question. Once this is done, the name to IP address mapping is cached in the local DNS server. The redirect method simply replaces the actual IP address for the domain name with the IP address of the nearest cache. This has the advantage that it will capture all attempts to access the cached data (i.e., from ftp or other protocols), and that, once one user requests the data, other users that use the same DNS server will automatically get the redirected IP address. The major disadvantage to this technique is that the entire content on the web site must be cached. This might cause problems for transactions (such as credit card verification) that actually might require access to the host computer. Another problem is caused by the latency of DNS entries (which in general will not be stored only on hosts belonging to the cache system or the content provider). It can take hours or even days for DNS entries to time out and be refreshed (on one Linux server, the default is 18 days!), so that it will be difficult for DNS redirect systems to dynamically modify the local redirect in response to network conditions or cache availability. Also, in this technique all users served by the same DNS cache must use the same content cache—there is no opportunity for further load balancing.

It is likely that both techniques are combined in practice—Akamai in particular is known to use both web page modification [Polouchkine, 2000] and DNS redirects [Johnson, 2000]. If a few popular entry points into a web site are redirected using DNS redirects to “redirect hosts”, then these hosts could then generate modified web pages referencing the appropriate local cache, which would then handle any remaining traffic. This would not require that cache servers monitor traffic, nor that they be located in the path from the user to the host. In addition, the location of the redirect hosts (which would rapidly pass traffic off to local caches) need not be changed dynamically and could be made redundant, so that the long latency of DNS caches would not be a problem. The system could also monitor network conditions and direct new users, even those with the same DNS servers, to different caches as conditions indicate.

The primary business goal of web caching systems is not reducing the cost of data transport, but in speeding delivery, reducing congestion and load balancing. In streaming media Zipf's law does not hold (every second of a broadcast is of more or less the same importance), nor can content be stored close to the user. Although the existing cache systems could be used for streaming media, and would offer load balancing and congestion reduction, the cost of this streaming is unclear. In the France Telecom internal report [Polouchkine, 2000], the cost of data transport for content providers is around $2000 per mbps per month, roughly 5 times the bulk rate for Internet data transport. In a caching system, such a cost seems reasonable (it amounts to a surcharge for speed of delivery), but it would be ruinously expensive for audio streaming. On the other hand, Akamai advertises its streaming abilities, and Avi Freedman (Akamai CIO) announced to the Spring 2000 ISP Conference that their goal was to reduce the cost to stream to the end user to $100/mbps/month. However, since the purposes of a web caching system and a streaming delivery system are different enough, the use of one system for both purposes is not likely to be very efficient. If streaming came to dominate the content delivery traffic, then streaming hosts would have to pay for cache storage and other expenses that they do not require, while cache requests (which tend to be bursty in nature) would have to contend with high volume constant streaming flows. Over all, it appears that cache based Content Delivery Networks are more expensive than direct unicasting at present, but may become cheaper in the future.

Even if Avi Freedman's goal for Akamai (of $100/mbps/month) is achieved, the costs will still be about one fourth of unicasting, or about $25 per month for the high quality, and $10 per month at the moderate quality. These numbers are comparable to the revenues from advertising, and so in the future it may be possible to be marginally profitable from streaming over caching content delivery systems.

Satellite Delivery Networks.

There are two basic types of satellite delivery systems of relevance here. One is direct delivery to the customer, typically at a change of $10 per month, and the other is delivery to the edge of the network.

Lewis [2000] provides a brief review of the XM and Sirius direct delivery systems aimed at the automotive market; note that they charge at present less than could be realized from advertising, although it is possible that limited advertising will be performed also. These systems will come with large capital costs (for launching the required satellites), and will need millions of listeners to be profitable given that these initial costs need to be recouped. It seems likely that these systems will not compete directly with Internet broadcasting, at least in the beginning in the USA.

Satellite systems that deliver to the edge of the network using Internet Protocols (IP satellite broadcasting) can be considered a form of multicasting, as one stream is sent up to the satellite and then sent down to as many Points of Presence (POPs) as have the appropriate satellite receivers. (Indeed, IP multicast is generally used internally for IP satellite data distribution.) The two companies currently providing this service are Cidera and IBeam, and a typical price (obtained from their sales representatives) is $0.40 per megabit of uplink. The costs to transmit are thus quite high, about $1 million per megabit per second per month, and the content host must also pay for the cost of the POPs (or convince users to pay for them), at a cost, by Cidera's estimate, of about $30,000 or more per POP. The financial advantage is that the network sends to multiple POPs for one fixed charge. These costs are divided among the POP's; for a network with 100 POPs the cost of delivering a stream would thus be about $2600 per month for the high quality stream, and $1050 for the moderate quality stream. This is not an efficient way of using the satellite bandwidth—it would be much more sensible to send one stream to each POP, and unicast or multicast multiple streams from the POP to end-users. This complicates the POP, and also means that it will be more difficult to avoid paying transit charges at the POP. If these POPs are to be located in commercial exchanges, there are further costs of about ˜$1500 per month (for one rack and roof space charges), $200 per month (for a cross-connect so that data can leave the building), plus data transit costs. If the data is unicast out of the POP, the data transport costs will be comparable to the general unicast cost, and so satellite delivery would very expensive (comparable to current cache delivery costs). If multicasting is possible, data transit costs should be on the order of $500 per month per POP.

TABLE 1
Estimated Monthly Costs for Satellite IP Broadcasting
(100 POPs - Multicasting from POPs assumed)

| Item | Cost | |
|---|---|---|
| Satellite Connect Charge | | |
| High Quality | $ | 250,000 |
| Moderate Quality | $ | 100,000 |
| POP Rack Charge | $ | 150,000 |
| POP Cross Connect Charges | $ | 20,000 |
| POP Data transit costs | $ | 50,000 |
| Amortized POP Equipment | $ | 80,000 |
| Total (High Quality) | $ | 550,000 |
| Total (Moderate Quality) | $ | 400,000 |

Table 1 provides a summary of these monthly cost estimates for satellite delivery, assuming multicasting at the POPs. If a broadcast has a nominal audience of 100,000, these charges work out to less than $6 per month per stream. Satellite Internet broadcasting can be profitable, but only if the transmissions to end users from the POPs is in multicasting, and only with a large total audience per stream. Roughly half the costs in Table 1 are due to the cost of the satellite channel, so that every additional channel will cost about $3 per month per stream for 100,000 listeners. In addition, each satellite only broadcasts to a limited geographical area (say, North America); broadcasts to another continent would require an extra cost for additional satellite time. The satellite channels are intrinsically limited (Cidera has a total bandwidth for all uses of 150 megabits per second), and the cost of satellite bandwidth is likely to increase if these channels become oversubscribed.

Terrestrial Radio.

Terrestrial radio earned $17 billion in advertising revenues in 1999, a 15% increase over 1998, and revenue growth has continued to be strong in 2000 [RAB, 2000]. Direct broadcasting expenses represent a small part of the total operating cost of a typical terrestrial mass market radio station, maybe as small as 10% of a typical $5 million per year operating budget. However, when viewed as a competitor to Internet broadcasting, the necessity of maintaining many separate broadcast facilities across the country (5656 FM radio stations in the US in November, 1997 [FCC, 1998]) means that terrestrial radio is saddled with high fixed costs, and also high levels of debt. In the most recent FCC review of the radio industry [FCC, 1998] broadcast radio profit margins are between 2 and 10 percent, which indicates that the current cost to broadcast a stream in terrestrial radio is about $20.00 per month. Note this includes all costs, not just the marginal costs of broadcast; what is not clear is how much these costs can be reduced in the face of sustained external competition. In general, according to the FCC [1998], the radio industry is associated with higher debt than the S&P 500, and yet has higher market value relative to its book value than the S&P 500. In the delicate understatement of a government report, the FCC report concludes that the various measures of industry return on investment “ . . . may signal that the firm(s) may not be facing vigorous competition. Such an interpretation would be consistent with one interpretation of the debt load evidence.” [FCC, 1998]

### SUMMARY OF THE INVENTION

The present invention is intended to solve the above-noted business and technical problems, to develop a critical mass of multicast deployment, and to provide a premier source for Internet broadcasting to millions of people. One important component of the invention is the development of a trusted third party Multicast Points of Presence (or MULTIPOPs) Network, termed “A Neutral Multicast Exchange”, which will enable access, via the trusted third party, to a large proportion of end-users who are attached to the Internet through regional or local Internet Service Providers (ISPs). The present invention is especially applicable to audio broadcasts to the portion of the population with broadband Internet access, since they can receive high quality streaming audio over the Internet.

The business goal of the present invention is to reduce the cost of Internet audio distribution to a level substantially below that of terrestrial broadcasting. Another goal is to develop the capability to distribute these broadcasts as widely as possible.

### BRIEF DESCRIPTION OF THE DRAWINGS

FIG. 1 shows the marginal cost of bandwidth and streaming profitability

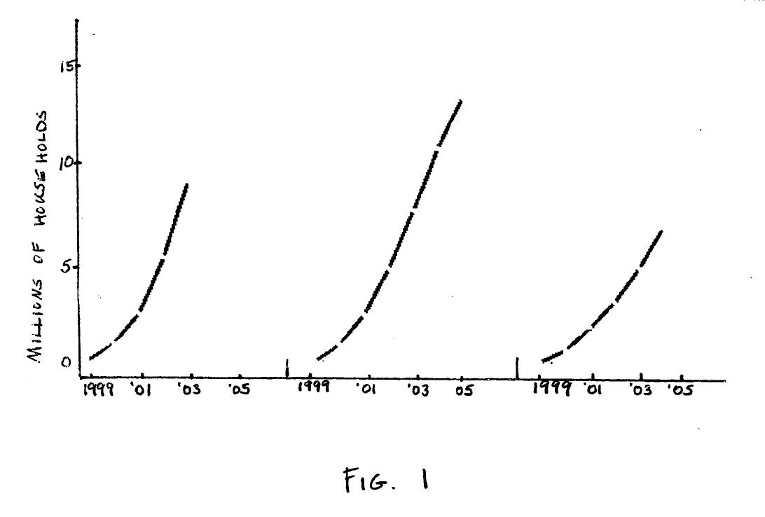

FIG. 2 shows an implementation of a TTP in conjunction with ISP's according to the present invention

### DETAILED DESCRIPTION OF PREFERRED EMBODIMENTS

Multicast Broadcasting.

The costs in multicasting are largely fixed costs, and so calculating the cost per listener or stream depends on the size of the audience. Where all multicasting is done by a Trusted Third Party (TTP) over the currently multicast enabled ISP's, these costs are dominated by personnel and other fixed costs, as is shown in Table 2. Two cases are shown, with 40,000 and 100,000 regular listeners, each listening for 2 hours per day. Largely because of the very high performers rights licensing fees, TTP itself will not operationally break even until the regular audience reaches 40,000. At this point, the total cost per stream or per listener is comparable to that of terrestrial radio, while when the audience reaches 100,000, the multicast price advantage becomes quite significant.

TABLE 2
Estimated Monthly Costs and Revenue for a TTP
Broadcasting in so-called “Stage 1” of a Business Plan

| Item | Cost/month | |
|---|---|---|
| Salaries, rent, etc. | $ | 75,000 |
| Connectivity | $ | 15,000 |
| Total | $ | 90,000 |
| Case 1: 40,000 listeners @ $ 7.60 CPM | | |
| for 2 hours per day | | |
| Revenue/month before license fees | $ | 222,500 |
| RIAA License fees @ $ 4.5 CPM | $ | 131,760 |
| ASCAP/BMI License fees @ 1.64% of revenue | $ | 3,650 |
| Profit (Loss) | ($ | 2900) |
| Cost per listener per month | $ | 5.64 |
| Cost per listener per month (net fees) | $ | 2.25 |
| Cost per stream per month | $ | 22.56 |
| Case 2: 100,000 listeners @ $ 7.60 CPM | | |
| for 2 hours per day | | |
| Revenue/month before license fees | $ | 556,250 |
| RIAA License fees @ $ 4.5 CPM | $ | 329,400 |
| ASCAP/BMI License fees @ 1.64% of revenue | $ | 9,123 |
| Profit (Loss) | $ | 128,000 |
| Cost per listener per month | $ | 4.29 |
| Cost per listener per month (net fees) | $ | 0.90 |
| Cost per stream per month | $ | 17.16 |
| Case 3: Marginal Profit listeners @ $ 7.60 CPM | | |
| for 2 hours per day | | |
| Marginal Profit per listener per month | $ | 2.23 |
| Marginal Profit per stream per month | $ | 8.93 |

Therefore, as a means to reach a wider audience a MULTIPOPs network is established in conjunction with TTP as follows.

Internet Connectivity: Transit, Peering, Exchanges and Multicasting

Wider dissemination of the broadcasts by a TTP requires developing a means of reaching more of the commodity Internet with its multicasts, which will require a means of sharing multicasts with many smaller and regional ISPs. This section will discuss the peering and transit relationships that are essential in the commodity Internet and how a TTP can position itself to have a strong competitive advantage by developing multicast peering relationships with the regional ISPs.

In one sense, there is no “Internet”; but, instead, there are networks of differing sizes and capabilities that are linked together in a variety of ways. No matter what the size of a given network, it is not linked to “the Internet”, but instead to other commercial, educational or governmental networks. These links must be paid for, with a service provider generally facing two distinct payments for any commercial network link; a payment for the physical link, called the local loop charge when the link passes through the Public Switched Telephone Network (PSTN), and a payment for the privilege of injecting their traffic into the other network, called a peering or transit charge. To set these charges in perspective, the local loop charge for a T1 line (at 1.5 megabits per second per month) in the DC area is about $500 per month, while the T1 transit charge is about $1000 per month. These charges (normalized in terms of cost per megabit per second) decline slowly with increasing line speed, until for very high speed connections the “bulk” transit charge is a small as $400 per megabit per second per month.

The commodity Internet is comprised of a large number of networks operated by different commercial, government and educational entities for a variety of purposes. Since these operators use different equipment with different, and generally incompatible, routing protocols, it is has proved necessary to divide the Internet into Autonomous Systems, where an Autonomous Systems (or AS, also frequently called a domain) is a network or set of networks under a single technical administration, using compatible routing policies. Data transport between different AS's occurs only at exterior gateways, where Border Routers (BRs) use an exterior gateway protocol to route packets to other AS's. A general description of the policy implications of the Autonomous System concept is given by RFC1930 [Hawkinson, 1996]. In order for a network to be multi-homed (to connect to more than one upstream provider), it has to be part of its own AS. Since a TTP is multicasting to several independent AS's, the TTP network needs to be multi-homed and thus TTP becomes essentially an AS.

Unlike the many industries dominated by a few large businesses, the many thousands of small and regional ISP's play an important role in the Internet and cannot be neglected if a mass broadcasting medium is to be developed. Public information about the distribution of the Internet among various service providers is sparse and unreliable—even the total number of ISP's is uncertain, with [Internet.com, 2000] providing a list of 9100 service providers. These can be roughly divided into backbone or Tier 1 providers (roughly, national and international networks) and Tier 2 and 3 providers (roughly, regional and local networks). The latest (1999) issue of the Boardwatch ISP directory [Boardwatch, 1999] lists 42 backbone providers; by the very rough estimates available, these have no more than half of the total end user market. Any universal multicasting will have to access the other half of the market serviced by small and mid-sized regional ISPs. Providing this service requires that a TTP be present in the Internet Exchanges commonly used by regional ISPs for peering, and may also require development of regional consortia for multicast distribution. As this “multicast peering” is an important aspect of the TTP's function, this section will examine the technical and business aspects of Internet exchanges in some detail. (Other common terms for an exchange are IX, for Internet Exchange, NAP, for Network Aggregation Point, MAE, for Metropolitan Area Exchange, and MAP, for Metropolitan Access Point).

In practice a regional ISP has little choice but to pay a backbone provider for transit so that its customers can communicate with any other site in the Internet, with such transit charges forming a significant fraction of total budget for most regional ISPs. An alternative to paying for local loop and transit fees is to locate in one or more Internet Exchanges. In an exchange, a number of different ISP's obtain rack space in a central facility, with current costs in the DC area being about $1000 per month per rack, $200 per month for a copper cross-connect, and $500 per month for a higher bandwidth fiber optic cross-connect.

There are strong economic motivations for smaller ISPs to collocate in an Exchange. Unlike the case with point to point Internet connections through the PSTN, connections between ISP's in an exchange can be done very rapidly (typically within 24 hours), and for a single, flat rate, cross-connect change. Two ISP's with significant traffic between them may decide to peer (exchange traffic without charging for usage, see Norton [1999]), and such peering can be done in an exchange for a small fraction of the cost of a direct PSTN link. Even in an exchange, a regional ISP will need a connection to a backbone ISP for transit, but in an exchange there is strong competition for such connections, and data transport can frequently be had for the bulk rate. In addition, an Exchange provides for great flexibility, if for some reason the transit provider is unsatisfactory, a new transit provider can frequently be in use with 24 hours in an exchange, versus the weeks required for local loop connection through the PSTN.

From the perspective of a large backbone ISP, exchanges until recently have been viewed as less attractive, in that they reduce the transit fees that can be collected from smaller ISP's. Until recently, it seemed that the exchange model might become obsolete through lack of backbone provider support; however, the rise of Application Service Providers (ASP's) and Content Distribution Networks (CDN's) has changed the exchange business climate significantly. These Internet based companies typically locate a substantial fraction of their total business within exchanges for basically the same reason that regional ISP's do: low transit costs and ease and flexibility of connectivity. (Indeed, MCT is interested in an exchange presence for exactly the same reasons.) Companies or businesses with a heavy exchange presence include Akamai and other cache based CDNs, IBeam and other satellite based CDNs, WorldStor and other storage area network providers, and IBM and other ASP's. As these companies are major customers of the backbone providers as well, this provides a strong business incentive for the large providers to adequately support Internet exchanges, and the exchange market is currently booming. In the Dulles, Va., area, for example, one company (Equinix) has 50,000 square feet of space, and is currently building out another 210,000 square feet in adjacent new buildings, while Exodus has 100,000 square feet currently in use, plus another building under construction, and there are 2 other exchange operators with smaller facilities, plus the very large MCI/WorldCom MAE-EAST facility nearby in Tyson's Corner. All of these exchanges report that they are fully rented or nearly so.

Exchanges can be broadly classified based on how neutral the exchange operator is. Equinix, PAIX and Neutral NAP, for example, are very neutral exchange operators, promising no direct competition with any of their customers. Other exchange operators, such as Exodus and Sprint, make no such promises; Exodus, for example, forces their customers to use their backbone for outside Internet access, and do not even call their facilities exchanges at all, but instead content hosting facilities. According to the present invention, a TTP is especially interested in the neutral exchanges, rather than the Exodus type business model.

Most Internet Exchanges do not provide any routing, but some do provide switching. In switched exchanges, there is a layer 2 network within the exchange, using switched technology such as a fast Ethernet, ATM, or a FDDI ring; and two providers connect through the switched circuit. Ferguson [1997] provides a detailed examination of the technical issues raised by a modern switched exchange handling gigabit per second data rates (such fast exchanges are commonly called GIGAPOPS, especially on the Internet2 network). Very fast switches are used so that the cross connections can proceed at the rate set by the physical media used by the layer 2 network; such switched networks are sometimes called switching fabrics. In other exchanges, there is no switched backbone, and providers must communicate through dedicated cross-connects. Although routing in exchanges is always up to the providers, some exchanges do mandate peering policies, while others, such as Equinix, leave that totally up to the individual providers. Since data transfers at exchanges are by definition between different AS's, the routers involved are of necessity Border Routers. Exchanges where the participants connect over a shared Local Area Network (LAN), such as Ethernet or a FDDI ring, typically mandate the use of the BGP 4 as the exterior gateway protocol to route packets to other AS's, while exchanges with only point to point links typically with leave the choice of a gateway protocol to the participants. Tables 3 and 4 provide a list of the known exchange providers and independent exchange points in the US, together with what is known about their members and the switching fabrics used, if any.

Multicast Peering at Internet Exchanges and MULTIPOPS

There are a few exchanges which call themselves “multicast friendly” or “multicast enabled.,” and there are two “Multicast Internet Exchanges,” or MIX's, which actively promote multicast peering. The general organization of a modern MIX is described by [LaMaster, 1999], while [Cisco, 1999] provides specific details for the configuration of Cisco router equipment for operation in a MIX. Elements of a MIX include the transfer of multicast data over a shared LAN, and therefore an exterior multicast gateway protocol, a multicast routing protocol, and a means of exterior multicast source discovery all must be specified. In the NASA Ames MIX [LaMaster, 1999], BGP 4+ is used for inter-domain route exchange, the Multicast Source Discovery Protocol (MSDP) is used for inter-domain source discovery, and Protocol Independent Multicast —Sparse Mode (PIM-SM) is used for multicast packet forwarding. The switching fabric is based on a FDDI ring dedicated to the multicast traffic, which is kept separate from unicast traffic. The PAIX exchanges use a similar architecture, with a separate switching fabric for MSDP/BGP 4+ and other multicast traffic.

According to the present invention, the purpose of using a TTP in a MULTIPOPS network is to facilitate the distribution and reduce the costs of multicast data transport, both for a TTP, for its broadcast clients, and for other multicast users who pay TTP for multicast data transit. A TTP faces a number of different challenges in creating MULTIPOPS in the 53 different exchange and collocation facilities listed in Tables 5a and 5b. In accordance with the present invention, a TTP will use MULTIPOPS to create a MIX type Multicast switched fabric architecture in those exchanges, such as the available Equinix exchanges, that do not have this already; the same technology will be used to interface with the multicast switched fabric already present in the multicast friendly exchanges (the Sprint NAP, MAE-West and the 5 PAIX exchanges). In other exchanges, particularly some of the smaller regional exchanges, point to point cross-connects may be the most cost effective means of distributing multicast traffic.

Further purpose of the invention is to develop multicast Internet broadcasting from a few channels that only reach the multicast enabled Internet, to a large number of channels that reach a substantial portion of all broadband recipients in the US. In a preferred embodiment of the invention, a reasonable goal from the standpoint of engineering is to have 100 channels of high quality audio being multicasted from 50 MULTIPOP location, with each location being able to service 1 million end users, for a total potential broadcast audience of 50 million These MULTIPOPS will provide multicast traffic, distributed from a TTP's central facility, or directly from the broadcasters, directly to any ISP's which cannot receive these transmissions directly or do not want to pay for multicast transit costs. As the ISP's receiving data from the MULTIPOPS form the end of the multicast distribution tree, we call them End-ISP's.

According to the invention, a TTP can be set up so that it will directly pay ISP's based on the size of the audience they (the ISP's) deliver. In a particularly preferred embodiment of the invention, the amounts of such payments may be determine by a direct measurement of the multicast audience provided by each ISP.

The next section examines the equipment and other costs involved with the setting up of the network according to the present invention network.

TABLE 3
List of US Exchange Providers
Equinix: http://www.equinix.net

| Location | Status |
|---|---|
| Ashburn Virginia | fully rented - new building available |
| | mid October |
| Austin, Texas | construction not yet started |
| Chicago, Illinois | available in October |
| Dallas, Texas | available in September |
| LA, California | available in October |
| Newark, New Jersey | fully rented |
| San Jose, California | space available |
| Secacus, New Jersey | construction not yet started |
| Seattle, Washington | construction not yet started |

NAP.NET/GTE http://www.napnet.net/

Chicago, Illinois
MAE-East (Vienna, Virginia)
MAE-West (San Francisco,
California)
Minneapolis, Minnesota

PAIX http://www.paix.net

Palo Alto, California
Vienna, Virginia
Seattle, Washington
Dallas, Texas
New York, New York

WorldCom MAE http://www.mae.net
ATM or FDDI Switched

| | |
|---|---|
| MAE East, Vienna, Virginia | 74 participants |
| MAE West, San Jose | 64 participants |
| California | |
| MAE Central, Dallas, Texas | 29 participants |
| MAE Houston, Houston | MAE Houston is not accepting new clients |
| Texas | |
| MAE LA, Los Angeles, | MAE LA is not accepting new clients |
| California | |

Colo.com: http://www.colo.com/english/

| Open Sites | Opening Soon | Leases Signed |
|---|---|---|
| Vienna, Virginia | Orlando, Florida | Jacksonville, Florida |
| Emeryville, California | Miami, Florida | Atlanta, Georgia |
| Los Angeles, | New York, New York | Louisville, Kentucky |
| California | | |
| San Francisco, | Chicago, Illinois | Charlotte, N. Carolina |
| California | | |
| Las Vegas, Nevada | Oakbrook, Illinois | Medford, Massachusetts |
| | Milwaukee, Wisconsin | New York, New York |
| | Dallas, Texas | Philadelphia, PA |
| | Fort Worth, Texas | Pittsburgh, PA |
| | Phoenix, Arizona* | Chesapeake, VA |
| | San Diego, California | Richmond, VA |
| | San Ramon, California | Sterling, VA |
| | Santa Clara, California | Detroit, Michigan |
| | Beaverton, Oregon* | Cincinnati, Ohio |
| | Seattle, Washington* | Cleveland, Ohio |
| | | St. Louis, Missouri |
| | | Minneapolis, Minnesota |
| | | Kansas City, Missouri |
| | | St. Louis, Missouri |
| | | Austin, Texas |
| | | Cordova, Tennessee |
| | | Austin, Texas |
| | | Houston, Texas |
| | | San Antonio, Texas |
| | | Englewood, Colorado |
| | | West Valley, Utah |
| | | Irvine, California |
| | | Portland, Oregon |
| | | Bothell, Washington |

*Accepting customers

TABLE 4
Independent Exchange Points in the US

| Name/ | | | Number of | Switch |
|---|---|---|---|---|
| URL | Location | Operator | Participants | Type |
| AMAP | Anchorage, Alaska, | Internet Alaska | 6 | |

http://www.artic.net/amap.html

| | | | |
|---|---|---|---|
| AMAP | Austin, Texas, | FC.Net | 8 |

http://www.fc.net:80/map

| | | | |
|---|---|---|---|
| BMPX | Boston, Mass, | HarvardNet | 11 |

http://www.bostonmxp.com

| | | | |
|---|---|---|---|
| BNAP | Baltimore, Md, | 9 | Ethernet |

http://www.baltimore-nap.net

| | | | | |
|---|---|---|---|---|
| NAP | Chicago, Il | Ameritech | 121 | ATM |

http://nap.aads.net/main.html

| | | | |
|---|---|---|---|
| CMH-IX | Columbus, Ohio | 6 | Ethernet/BGP4 |

http://www.cmh-ix.net

| | | |
|---|---|---|
| COX | Oregon | 3 |

http://www.centraloregon.net

| | | | |
|---|---|---|---|
| DIX | Denver, Colorado | 6 | Ethernet |

http://www.thedix.net/

| | | | |
|---|---|---|---|
| MAX | Denver, Colorado | 6 | Ethernet/BGP4 |

http://www.themax.net/

| | | | | |
|---|---|---|---|---|
| NeutralNap | McLean, Virginia | Neutral Nap | 9 | Ethernet |

http://www.neutralnap.net

| | | | | |
|---|---|---|---|---|
| Compaq NAP | Houston, Texas | Compaq | 5 | BGP 4 |

http://www.compaq-nap.net/

| | | | |
|---|---|---|---|
| MAGIE | Houston, Texas | 11 | Ethernet/BGP4 |

http://www.compaq-nap.net/

| | | | | |
|---|---|---|---|---|
| HIX | Honolulu, Hawaii | Lava.net | 13 | BGP 4 |

http://www.lava.net/hix/frame relay/pvc/bgp4

| | | | |
|---|---|---|---|
| IndyX | Indianapolis, IN | 23 | ATM - Ethernet |

http://www.indyx.net/

| | | |
|---|---|---|
| LAP | Los Angeles, CA | Ethernet |

http://www.isi.edu/div7/lap

| | | | |
|---|---|---|---|
| Florida MIX | Miami, FLorida | Bell South | 7 |

http://www.bellsouthcorp.com/proactive/documents/render/33642.vtml

| | | |
|---|---|---|
| NAP | Nashville, TN | 14 |

http://nap.nashville.net/

| | | | |
|---|---|---|---|
| NYIIX | New York, New York | Telehouse | 31 |

http://www.nylix.net

| | | |
|---|---|---|
| BIGEAST | New York, New York | ICS Networks |

http://www.bigeast.net/

| | | | |
|---|---|---|---|
| SprintNap | Pennsauken, NJ | Sprint | BGP 4+ |
| PHLIX | Philadelphia, PA | | Ethernet |

http://www.phlix.net

| | | | |
|---|---|---|---|
| PITX | Pittsburg, PA | 4 | Ethernet |

http://www.pitx.net/

| | | | |
|---|---|---|---|
| OIX Oregon | ANTC | 8 | Ethernet |

http://antc.uoregon.edu/OREGON-EXCHANGE/

| | | | | |
|---|---|---|---|---|
| SD-NAP* | San Diego, CA | CAIDA | 20 | Ethernet/FDDI |

http://www.caida.org/projects/sdnap/

| | | | | |
|---|---|---|---|---|
| Pacbell NAP | San Francisco, CA | Pacific Bell | 62 | ATM |

http://www.pacbell.com/Products_services/Business/Prodinfo_1/1,1973,146-1-6,00.html

| | | | | |
|---|---|---|---|---|
| SIX | Seattle, Washington | Altopia | 37 | BGP 4 |

http://www.altopia.com/six/

| | | |
|---|---|---|
| PNW | Seattle, Washington | 15 |

http://www.pnw-gigapop.net/

| | | | |
|---|---|---|---|
| REP | Utah | 12 | BGP4 |

http://utah.rep.net/
*It is against the policy of the SD-NAP to allow participants to serve content co-located at the NAP. This NAP may therefore not be suitable as a MULTIPOP location.

TTP at the Exchange Points: Equipment Provisioning and Costs

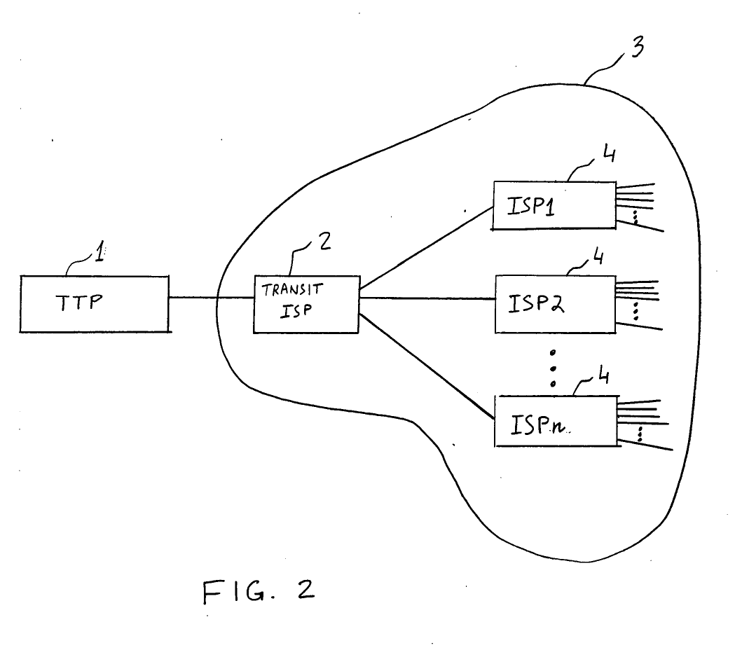

As illustrated in FIG. 2, in a preferred embodiment, a TTP 1 would be set up in conjunction with a, for example, 50 site MULTIPOP network 3 (which includes transit ISP's 2 and end-ISP's 4), with each MULTIPOP being provisioned for 100 high quality audio streams at 250 kbps each. The major considerations for equipment at the sites are routing the incoming and outgoing traffic, processing MSDP and BGP 4+ messages, monitoring of user activity, and monitoring of the health of the MULTIPOP. The current equipment lists for the MULTIPOPS is contained in Tables 5a and 5b, while Table 6 compares estimated expenses with potential revenues. It is to be expected that a TTP will enter into Service Level Agreements (SLA) with customers to guarantee a high level of multicast availability for the MULTIPOPS network. Given the necessity of having unmanned equipment in many remote locations, any such SLA can only be met by, in a particularly preferred embodiment of the invention, redundant provisioning (i.e., “hot spares”), and with the ability to remotely monitor conditions. This redundant provisioning is reflected in Tables 5a and 5b.

The goal of 100 high quality audio streams implies a downstream transit data rate of 25 mbps, which might be received either as multicasts or unicasts, depending on the connectivity to the exchange. At the bulk data rate of $400/mbps/month over the commodity Internet, this implies a data transport charge of $10,000 per MULTIPOP per month. (This would be, even for 50 MULTIPOPS, substantially cheaper than the cost of point to multipoint satellite broadcast, and so we do not consider this option further.) In order to process these high data rates, a medium to high end router will be required; for example, a CISCO 7206 VXR routers, outfitted as described in Table 5b, with the bulk discount price from a vendor. Two routers are assumed for redundancy.

The return (upstream) traffic from a MULTIPOP also must be considered. If each MULTIPOP is provisioned to service an simultaneous audience of 1 million, and each listener sends back one 400 byte receiver report every 100 seconds for auditing purposes (as would be the case in a TTP according to a preferred embodiment of the invention), then the total upstream traffic is 32 mbps, which is comparable to the downstream traffic. Since it may not be possible to receive 50 times this traffic at a TTP's central facility, in a particularly advantageous embodiment of the invention, two computers at the MULTIPOP will be dedicated to reading the receiver reports and providing summary reports back to a TTP. There may also be provided one additional computer as a hot spare. Any of these three computers can be used for monitoring conditions at the site, as this is a much less CPU intensive task.

While many Internet exchanges do not force the use of particular Local Area Network (LAN) technology, some exchanges do, and the LAN equipment will thus vary if we decide to make those exchanges into MIXes. In Tables 5a and 5b show cases where Ethernet 10/100 LAN equipment is used (as this is widely used in known Exchanges). Other LAN technology that it might be required for some exchanges are ATM, FDDI or gigabit Ethernet. It is to be expected that the provisioning in these exchanges might cost more, both because the equipment is intrinsically more expensive and because we would be buying fewer total units. It is assumed that an average of 20 End-ISPs at each site will receive the transmissions, and that is the average of the known ISPs per site in Table 4. The HP 9308M Procurve with Module J4140 cards could easily handle this level of traffic, and with extra modules even the largest exchanges could be serviced.

All of the equipment for the MULTIPOP will fit into two racks, at a typical rate of $1000 per rack per month. Optical fiber cross-connects to 20 ISP's, at a typical rate of $500 per month, will be a major part of the total expense (Table 6). A total of 5 employees should be sufficient to monitor and maintain the entire MULTIPOP network, and it is assumed that at least one site visit per location per year will be required.

A major question regarding expenses is the necessity of paying the End-ISP's for data transport. If this is not necessary (see Case 1 of Table 6), then the monthly cost of a MULTIPOP is fairly small, and a very small audience could render the MULTIPOP profitable. In the case where every End-ISP both receives the full set of transmissions and requires payment for each transmission (Case 2 of Table 6), these payments dominate the MULTIPOP expense budget, and a fairly large audience of 60,000 per MULTIPOP would be required for profitability.

TABLE 5a
Equipment Provisioning for TTP MULTIPOPS

| Equipment | Purpose | Cost | | Number | Total Cost | |
|---|---|---|---|---|---|---|
| Linux Computer | POP Monitor | $ | 5,000 | 1 | $ | 5,000 |
| Linux Computers | Server | $ | 5,000 | 2 | $ | 10,000 |
| Cisco - 7206 VXR | Router | $ | 31,042 | 2 | $ | 62,084 |
| HP Procurve 9308M | Ethernet Switch | $ | 13,000 | 2 | $ | 26,000 |
| HP Module J4140A | Ethernet ports | $ | 11,259 | 4 | $ | 45,036 |
| Cabling, rack mounts, etc. | Infrastructure | | | | $ | 1,000 |
| Installation + 5% Margin | | | | | $ | 9,500 |
| Total | | | | | $ | 158,620 |

NOTE:
Each HP Module J4140A provides 24 10/100 Ethernet ports.

TABLE 5b
Cisco 7206 VXR Provisioning

| | | | Discount | |
|---|---|---|---|---|
| Item | List Price | | Price | |
| 7206VXR Chassis | $ | 7000 | $ | 4760 |
| PWR-7200-AC Power | $ | 3000 | $ | 2040 |
| FR72H - Firewall | $ | 5000 | $ | 3400 |
| NPE-300 Processor | $ | 7500 | $ | 5100 |
| MEM-SD-NPE-128 | $ | 1800 | $ | 1224 |
| MEM-I/O-FLC16M | $ | 400 | $ | 272 |
| FR-WPP72 Wan Prot | $ | 3400 | $ | 2312 |
| FR-IR72 IntDomain | $ | 3400 | $ | 2312 |
| C7200-I/O-FE | $ | 2500 | $ | 1700 |
| PA-FE-TX | $ | 2500 | $ | 1700 |
| PA-2T3 | $ | 18000 | $ | 12240 |
| Totals | $ | 54500 | $ | 37060 |

NOTES: The equipment lists for Tables 5a and 5b are examples only, as there is similar equipment with comparable capabilities available from multiple vendors for every function. Given the large number of units required, it may be possible to reduce the total cost by entertaining multiple bids. This equipment list also assumes Ethernet switching at the POP. The pricing for other switching fabrics may vary.

TABLE 6
Estimated Monthly Costs for Each MULTIPOP
in Stage 2 of the Business Plan

| Item | Cost/month | |
|---|---|---|
| Incoming (transit) Connectivity | $ | 10,000 |
| Equipment (3 year amortization) | $ | 4,500 |
| Rack Fees | $ | 2,000 |
| 20 Cross-Connects (to 20 End-ISP's) | $ | 10,000 |
| 5 employees for monitoring + burden/50 MULTIPOPS | $ | 1,000 |
| Miscellaneous, including travel | $ | 2000 |
| Case 1: No transport fees to End-ISPs | | |
| Total | $ | 29,500 |
| Minimum Profitable MULTIPOP Audience* | | 14,000 |
| Case 2: $ 5000/month transport fees to 20 End-ISPs | | |
| Total | $ | 129,500 |
| Minimum Profitable MULTIPOP Audience* | | 60,000 |
| Minimum Profitable MULTIPOP Audience/End ISP | | 3,000 |

*Assuming the marginal profit of Table 2

### Conclusion

The present invention proposes a means for developing multicasting to the status of a mass medium, similar in its reach to Cable Television. As broadband access increases towards universal penetration over the next decade, multicast distribution of audio (and later video) transmissions will develop into a major industry.

While the present invention describes certain implementations of a network which employs a TTP in conjunction with ISP's to deliver multicast broadcasts, other implementation are possible. Therefore, the scope of the present invention is not limited to the above specific implementations, but is rather defined by the following claims.

1. A system for delivering information on the Internet to end users, said system comprising:
an autonomous source of multicast transmission of said information; and
a MULTIPOPS network which includes a plurality of multicast enabled Internet service providers;
wherein said autonomous source delivers said information to said MULTIPOPS and said MULTIPOPS provide said information to said Internet service providers for distribution to said end users.

2. The system as claimed in claim 1 wherein said information comprises at least one of audio and video data.

3. The system as claimed in claim 1 wherein said autonomous source comprises means for measuring the amount of said end users receiving said information.

4. A method of delivering information on the Internet to end users, said method comprising:
generating a multicast transmission of said information; and
providing said multicast transmission to at least one MULTIPOP within a MULTIPOPS network which includes a plurality of multicast enabled Internet service providers;
wherein said at least one MULTIPOP provides said information to said Internet service providers connected to said least one MULTIPOP for distribution to said end users.

5. The method as claimed in claim 4 wherein said information comprises at least one of audio and video data.

6. The method as claimed in claim 4 further comprising measuring the amount of said end users receiving said information.
